(19) United States
(12) Patent Application Publication
(10) Pub. No.: US 2008/0071422 A1
(43) Pub. Date: Mar. 20, 2008

(54) Process Installation Comprising a Plurality of Field Appliances

(75) Inventor: Chris Abbot, Wehr (DE)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co, kg, Maulbury (DE)

(21) Appl. No.: 10/585,580

(22) PCT Filed: Dec. 28, 2004
(86) PCT No.: PCT/EP04/53714

§ 371 Date: Apr. 26, 2007

(30) Foreign Application Priority Data
Jan. 8, 2004 (DE) 102004001474.4

(51) Int. Cl. G05B 19/418; G05B 19/04

(52) U.S. Cl. 700/247

(57) ABSTRACT

In a process installation having a plurality of field devices FLS, PS, CU, which exchange data with a control room CR via a signal line SL, wherein the signal line SL is designed for a conventional, first data transmission technology having a low data transmission rate (less than 10,000 baud), at least one field device CU applies for data transmission with the control room CR, via a second data transmission technology, which permits a greater data transmission rate and/or more functionality than the first transmission technology and which uses the existing signal line SL as the communication medium.

The invention relates to a process installation, or plant, with a plurality of field devices, to a method for transmitting data in a process installation having a plurality of field devices, as well as to a method for modernizing a process installation having a plurality of field devices, as defined in the preamble of claim 1.

Modern process installations are, today, normally monitored and controlled from a central control room.

The information needed for the tasks, monitoring and control, are transmitted between the individual process components and the control room in digital form via a corresponding signal line.

Especially in the case of tank farms, refineries, pipelines, etc., long signal lines of multiple kilometers are needed, in order to connect the individual process components with the control room.

The transmission standards (HART, Profibus, Foundation Fieldbus) known in the field of process automation technology are not suited, or are only conditionally suited, for such long signal paths.

Therefore, often used in the case of existing tank farms are various communication systems (communication protocols, or communication technologies), such as, e.g. Whessoematic WM550, Varec Mark/Space, Sakura V1, Tiway, etc., which are especially adapted for data transmission over relatively long signal lines.

An additional reason for using these proprietary communication systems is also that, at the time of introduction of digital communications into the tank-farm field, the fieldbus systems of today were not yet even developed.

A disadvantage of these communication systems in use now lies in their low data transmission rates, which among other things, is a function, also, of the signal lines being used. The signal lines are mostly non-shielded and non-twisted, copper-wire lines.

For higher data transmission rates, fieldbus technology, however, uses mostly twisted, and as required, even shielded signal lines.

In the case of a change from the conventional data transmission rates to higher data transmission rates, at least a costly replacement of the signal lines would be necessary.

In many cases in existing tank farms, also older field devices are used, which no longer correspond to the absolutely newest state of the art.

Newer field devices possess much improved functionalities and work, therefore, at higher data transmission rates.

In the modernizing of an existing tank farm, the following problems result from this picture.

A modernizing is only possible when all field devices which work according to the previously used, proprietary communication systems are replaced by modern devices and/or the signal lines are correspondingly adapted, i.e. completely replaced. These measures would be connected with significant costs and, at the same time, would mean an extended downtime for the entire process plant.

As a rule, within a communications loop, always only individual devices or device-groups are replaced. This requires a compatibility, with reference to the used transmission path of the new devices and protocols, with the old devices and protocols.

An object of the present invention is, therefore, to provide a process installation having a plurality of field devices that enables, without great expense, an improved communication with e.g. higher data transmission rates, expanded functionalities or more current protocols (e.g., TCP/IP).

This object is achieved by features as defined in claim 1.

An essential idea of the invention is not to replace the existing signal lines, but instead to use them also for the faster data transmission between the field devices and the control room, according to a new data transmission technology.

Advantageously, the new transmission technology corresponds to the DSL-technology (digital subscriber line) already used in the telecommunications field.

The invention will now be explained in greater detail on the basis of an example of an embodiment presented in the drawing, the figures of which show as follows:

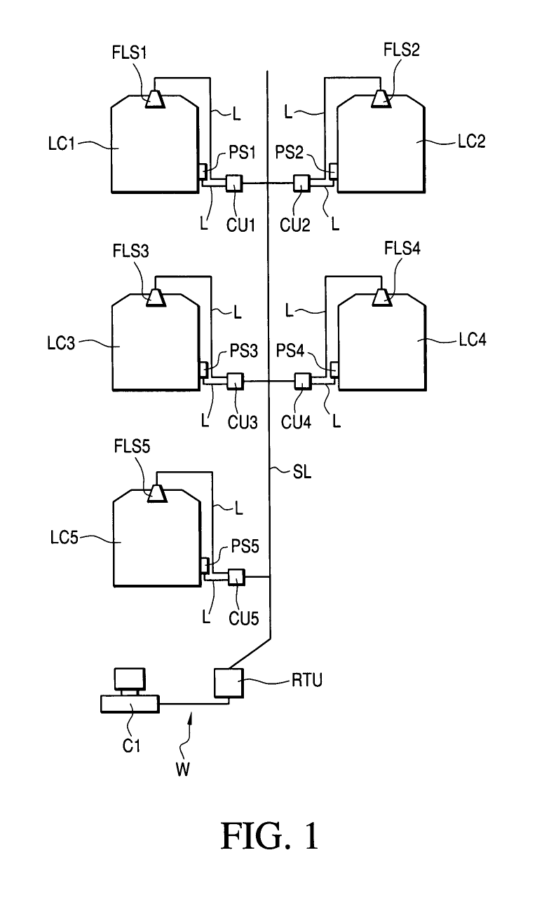

FIG. 1 a tank farm with a plurality of liquid containers; and

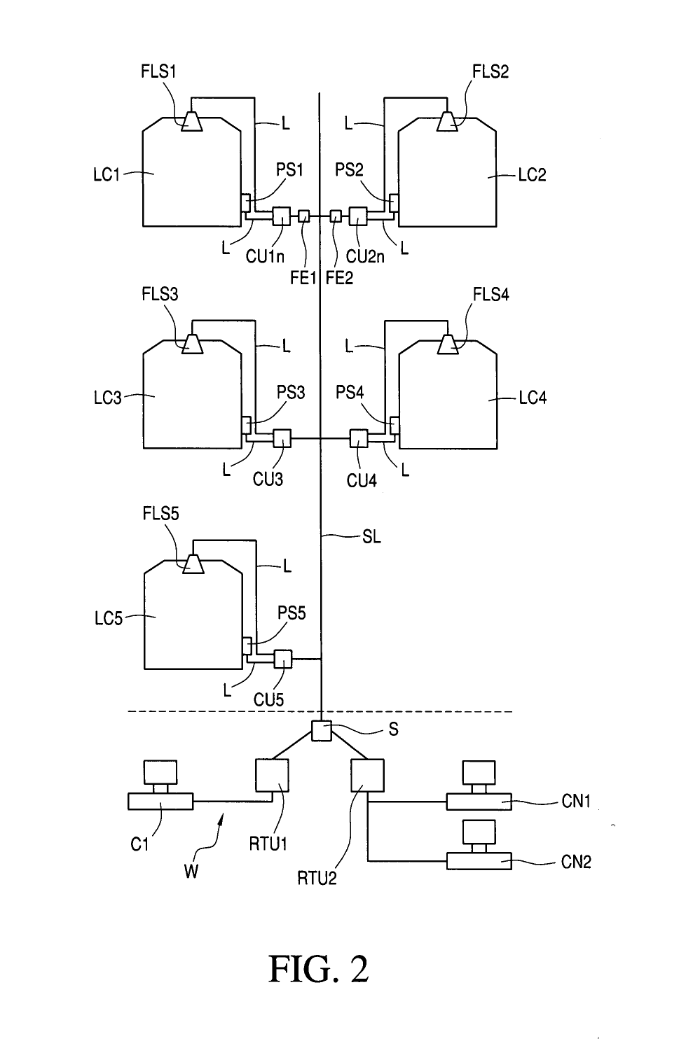

FIG. 2 a tank farm of the invention.

FIG. 1 shows schematically, as an example of a process installation, a typical tank farm having a plurality of liquid containers LC1, LC2, LC3, LC4, LC5. These are storage containers for crude oil. A tank farm can extend over a range of several kilometers.

In order to register the fill levels in the storage containers, each of the liquid containers LC1-LC5 includes a fill level sensor FLS1-FLS5 and a pressure sensor PS1-PS5. Mostly used in this field of application is the radar method of fill level measurement.

The sensors are connected via 2-wire lines L, e.g. according to the HART-standard, with a converter unit CU2-CU5, from which a signal line SL leads to the control room CR.

In the control room, a computer C1 is provided, which serves as control system (host computer) and which also serves, among other things, for visualizing the current fill levels in the storage containers LC1-LC5, e.g. with the aid of the software Fuelsmanager of the firm Endress+Hauser. The computer C1 is preceded by a remote terminal unit RTU1, in which the data coming from the sensors are stored and made available for retrieval by the computer C1 via an RS232/RS485 interface, or network interface, as the case may be.

For the data exchange between the sensors and the control room CR, in the near-range of the liquid containers, HART technology is used, and for long distance transmission to the control room, a proprietary data transmission technology according to an appropriate industry standard, such as, e.g. Whessoematic WM550, Varec Mark/Space, Sakura V1, Tiway, is used.

In the case of the converter units CU1-CU5, these can be e.g. tank-side monitors of the firm Endress+Hauser.

FIG. 2 shows a tank farm of the invention. In contrast to FIG. 1, the old converter units CU1 and CU2 are replaced by new converter units CU1n and CU2n. These new converter units CU1n and CU2n communicate with the control room no longer according to the relatively slow, previously used transmission technology, but instead according to a new data transmission technology. The data transmission occurs over the available signal line SL. In contrast to FIG. 1, each of the new converter units CU1n, CU2n is provided with a filter unit FU1, FU2 (the filter units are expediently provided in the new converter units CU1n, CU2n, i.e. they are optional), and, in the control room, a splitter S is provided in the signal line SL.

The old converter units must likewise be equipped with filter units, should the input circuit of the old units react sensitively to the frequency band of the new transmission technology.

Additionally provided in the control room are further computers CN1, CN2 as control systems. The separate computer units C1, CN1 and CN2 can also be replaced by a single process control system; the computers CN1 and CN2 are, thus, optional.

The manner in which the invention functions will now be explained in greater detail.

The field devices CU3, CU4, CU5 on the tank containers LC3-LC5 communicate with the control room in conventional manner according to a first data transmission technology with a relatively low data transmissions rate (less than 10,000 baud).

The new field devices CU1n and CU2n communicate with the control room according to a second data transmission technology (for example, DSL-technology). The already installed signal line SL is used as the communication medium. The second data transmission technology allows, in comparison to the first technology, expanded possibilities, e.g. more commands, diagnoses and/or a considerably higher data transmission rate, as compared with the previously used technology. Consequently, data from the sensors FLS1, PS1, or FLS2, PS2, as the case may be, are transmitted considerably faster, and/or with expanded functionality, to the control room CR.

The two transmission technologies do not interact, since separate data transmission channels having different frequency bands are used.

The conventional communication technologies use the frequency band up to 4 kHz. The DSL technology uses the frequency band greater than 30 kHz (ADSL), or 138 kHz (T-DSL), as the case may be.

For DSL-technology, a simple 2-wire copper cable is sufficient, so that the existing signal line SL can continue to be used. The optional filter units FU1 and FU2 filter the appropriate signals out and feed them to the field devices CU1n, respectively CU2n.

The splitter S separates the signals according to the data channels and feeds them to the remote terminal units RTU1, RTU2, respectively. The remote terminal unit RTU2 works according to the second data transmission technology and makes the data available for the computer units CN1 and CN2 via corresponding interfaces (e.g. Ethernet).

Alternatively, the remote terminal units RTU1 and RTU2 can also be connected with a common communication network for all computer units C1 and CN1, CN2.

Another option is to connect new field devices designed for the second data transmission technology directly with the signal line SL.

Significant advantages of DSL technology are the considerably higher data transmission rate and the expanded functionality as compared with the old protocols.

Due to the higher data transmission rate, it becomes possible to transmit entire programs, e.g. software updates, from the control room to the individual field devices quickly, simply, and certainly. The programs, which can even involve a plurality of MB, are then stored in appropriate memory (e.g. flash-EEPROM).

Until now, it has only been possible to transmit programs directly to field devices via a service-interface provided at the field device. To this end, the correct field device has to be found by a service technician and connected with a portable computing unit (e.g. laptop), before the program could be transferred.

Disadvantageous with the previous manner of processing has been the effort associated with a software update. The field devices are, in part, installed far-removed from the control room.

Some of the field devices are also only accessible with difficulty and rough climatic, environmental conditions (wind, ice, rain, snow, etc.) oppose the work. The computer units are not always designed for these rough environmental conditions. In the case of a field device such as the Prosonic S of the firm, Endress+Hauser, a software update via a service interface can last up to an hour, because, also, the data transfer speed of the service interface is very limited.

An additional advantage offered by the use of DSL technology is to be seen in the fact that the electronic components needed for the new field units have already been developed and also can be purchased.

Since these components are often used for Internet access, both in private as well as also in business applications, the high numbers in which they are produced makes them especially cost favorable. Need for complicated new developmental efforts are, therefore, not encountered.

1-10. (canceled)

11. A process installation having:
a control room;
a signal line;
a plurality of field devices, which exchange data with said control room via said signal line SL, wherein:
said signal line SL is designed for a conventional first data transmission technology having a low data transmission rate (smaller than 10,000 baud);
at least one field device, for data exchange, operates with a second data transmission technology, which permits a greater data transmission rate and/or an expanded functionality than the first transmission technology, and which uses, as a communication medium, the existing signal line SL.

12. The process installation as claimed in claim 11, wherein:
the first and second data transmission technologies use separate data transmission channels occupying different frequency bands.

13. The process installation as claimed in claim 11, wherein:
the first data transmission channel occupies a frequency band up to 4 kHz, and the second data transmission channel occupies a frequency range greater than 4 kHz.

14. The process installation as claimed in claim 11, wherein:
said signal line SL is a 2-wire line.

15. The process installation as claimed in claim 11, wherein:
said signal line SL is a copper 2-wire line with a bandwidth of about 1 MHz.

16. The process installation as claimed in claim 11, wherein:
said first data transmission technology operates according to an industrial standard, e.g. Whessoematic WM550, Varec Mark/Space, Sakura V1, Tiway, Profibus, HART, FF.

17. The process installation as claimed in claim 11, wherein:
said second data transmission technology corresponds to DSL (digital subscriber line) technology.

18. The process installation as claimed in claim 11, wherein:
the process installation, is a tank farm with a plurality of tanks LC1, LC2, LC3, LC4, LC5 for containing liquid.

19. A method for modernizing a process installation with a plurality of field devices, which exchange data with a control room CR via a signal line SL, comprising the step of:
older field devices which transmit data to a control room according to a first transmission technology by new field devices, which work according to a second transmission technology, wherein:
the data transmission according to the second transmission technology occurs in a second channel on the existing signal line SL, so that the data transmission signals of the different transmission technologies do not influence one another.

20. A method for communication in a process installation with a plurality of field devices, comprising the step of:
using an existing signal line SL for a first transmission technology and also for a second transmission technology.
